(19) United States
(12) Patent Application Publication
(10) Pub. No.: US 2018/0102637 A1
(43) Pub. Date: Apr. 12, 2018

(54) SURGE SUPPRESSOR

(71) Applicant: Phoenix Contact GmbH & Co. KG, Blomberg (DE)

(72) Inventors: Jan-Erik Schmutz, Detmold (DE); Jan Hegerfeld, Paderborn (DE); Martin Wetter, Detmold (DE)

(73) Assignee: Phoenix Contact GmbH & Co. KG, Blomberg (DE)

(21) Appl. No.: 15/728,829

(22) Filed: Oct. 10, 2017

(30) Foreign Application Priority Data
Oct. 10, 2016 (DE) 10 2016 119 202.3

(51) Int. Cl. H02H 3/20

(52) U.S. Cl. CPC H02H 3/20

(57) ABSTRACT

A surge suppressor with a housing, a varistor located in the housing, an electrically conductive connecting element and at least one isolating interrupter. The isolating interrupter is movable relative to a first terminal of the varistor out of a first position into a second position, in the normal state of the surge suppressor, a first end of the electrically conductive connecting element being connected to the first terminal of the varistor in an electrically conductive manner and the isolating interrupter being held in its first position. When a critical state of the varistor is reached, the isolating interrupter is moved into its second position in which a segment of the interrupter is located between the first end of the electrically conductive connecting element and the first terminal. Reliable disconnection from the power system is ensured by the arc formed being moved into at least one partially closed chamber.

### BACKGROUND OF THE INVENTION

### Field of the Invention

The invention relates to surge suppressor with a housing, with an overvoltage-limiting component located in the housing, with an electrically conductive connecting element and with at least one isolating interrupter, the overvoltage-limiting component having a first terminal and a second terminal and the isolating interrupter being located to be able to move relative to the first terminal of the overvoltage-limiting component so that it can be moved out of a first position into a second position.

### Description of Related Art

Overvoltage protection is defined as the protection of electrical and electronic devices against overly high electrical voltages. The required measures for protection of systems and devices are divided into different stages according to the overvoltages which are to be expected. The protective gear for the individual stages differs in particular by the level of the discharge capacity and the protection level. Surge arresters of the second protective stage, so-called type 2 surge arresters, have predominantly varistors as overvoltage-limiting protective elements which enable a high discharge capacity at a low residual voltage. In addition however gas-filled surge arresters or diodes can also be used as overvoltage-limiting protective elements. In the normal state varistors have relatively low leakage currents which can however rise over time due to ageing or brief overloading. The heating which is associated with this in these cases can lead to thermal destruction of the varistor; this in turn can damage adjacent parts or devices. Therefore thermal destruction of the varistor must be prevented, for which in the prior art thermal disconnectors are used which, when a boundary temperature is exceeded, disconnect the varistor from the power system which is to be protected.

German Patent DE 42 41 311 C2 also discloses a surge suppressor which has a thermal disconnector for monitoring the state of a varistor. The surge suppressor has two terminal contacts for connection to the current path which is to be protected. The first terminal contact is connected via a flexible conductor to a conductive connecting element whose end facing away from the flexible conductor is connected via a soldered joint to a terminal lug which is provided on the varistor. The other terminal contact is securely connected to a second terminal lug on the varistor via a flexible conductor. The conductive connecting element is exposed by a spring system to a force which leads to the connecting element being moved linearly away from the terminal lug when the soldered connection is broken so that the varistor is electrically disconnected under thermal overload. So that an arc which forms when the gap opens is quenched, it is necessary for the connecting element to have as great a distance as possible to the terminal lug after the soldered connection is broken; this necessitates a relatively large unit volume of the surge suppressor.

The thermal disconnectors which are used in the known surge suppressors and which are based on the fusion of a soldered connection must perform several tasks. In the normal state of the surge suppressor, i.e. in the non-disconnected state, a reliable and good electrical connection must be ensured between the assigned terminal contact and the overvoltage-limiting component. When a certain boundary temperature is exceeded, the gap must ensure reliable disconnection of the overvoltage-limiting component and durable dielectric strength and tracking resistance. If the surge suppressors are to have dimensions as small as possible so that the surge suppressors do not exceed for example the dimensions which are dictated for mounting rail devices, this leads to their having only a relatively low quenching capacity when used in DC voltage electrical systems.

U.S. Pat. No. 6,430,019 B1 discloses a surge arrester with a thermal disconnector which at the end of an elastic contact tongue is connected via a soldered joint to one terminal of the varistor. If unallowable heating of the varistor occurs, this leads to fusion of the soldered connection so that the end of the deflected contact tongues springs away from the terminal of the varistor. At the same time an isolating interrupter travels between the contact tongue and the varistor in order to quench the arc which may arise. Since the isolating interrupter has smaller dimensions than the varistor, only a partial region of the varistor is shielded by the interrupter so that it cannot be precluded that the arc or the plasma which forms in the region of the contacts around the interrupter will close again so that a current continues to flow via the varistor.

The initially described surge suppressor is also known from German Utility Model DE 20 2014 103 262 U1. In this surge suppressor, the overvoltage-limiting component is a gas-filled surge arrester so that this surge suppressor can also divert large pulse currents. The surge suppressor, moreover, has an isolating interrupter which can be moved out of a first position into a second position by the force of a spring element. In the surge suppressor the first terminal contact is stably connected in an electrically conductive manner to the first electrode of the surge arrester. In the normal state of the surge suppressor, i.e. when the surge arrester is not unduly heated, the first end of an electrically conductive connecting element is electrically connected via a thermally breaking connection to the second electrode of the surge arrester, while the second end of the connecting element is conductively connected to the second terminal contact. In the normal state of the surge suppressor moreover the isolating interrupter is held in its position by the connection which has been established between the first end of the conductive connecting element and the second electrode of the surge arrester.

If the surge arrester has been heated so dramatically due to a lasting overload of the surge suppressor that the boundary temperature is exceeded, the soldered connection fuses and thus the thermal connection between the electrically conductive connecting element and the assigned electrode of the surge arrester is broken. The isolating interrupter is then shifted into its second position by the force of the spring element. In this position a segment of the interrupter is located between the first end of the electrically conductive connecting element and the assigned electrode of the surge arrester so that the direct connection between the conductive connecting element and the surge arrester is broken. But in doing so however there is the risk that due to the plasma which is still present between the end of the connecting element and the assigned terminal of the surge arrester there remains an arc so that a current continues to flow via the surge arrester; this can lead to thermal destruction of the surge suppressor.

### SUMMARY OF THE INVENTION

Therefore, the object of this invention is to make available the above described surge suppressor in which reliable disconnection of the surge suppressor from the electrical system is ensured and thus thermal destruction of the overvoltage-limiting component is prevented.

This object is achieved in the surge suppressor with the features of claim 1 in that the isolating interrupter is made such that an arc which arises when the electrical connection between the first end of the electrically conductive connecting element and the first terminal of the overvoltage-limiting component is broken is moved into an at least partially closed chamber. The deflection of the arc by the isolating interrupter leads first of all to the length of the arc being increased, as a result of which the arc voltage, i.e. the voltage which is necessary for maintaining the arc, increases. Moreover, with the arc the plasma which is present in the region between the first end of the electrically conductive connecting element and the first terminal of the overvoltage-limiting component is also moved out of the region between the contacts. Thus, a guided discharge of plasma out of the region between the contacts which has been caused by the movement of the isolated interrupter takes place; this likewise leads to an increase of the arc voltage. As a result, an arc which forms when the connection is opened between the conductive connecting element and the terminal of the overvoltage-limiting component is quenched and re-ignition of an arc is reliably prevented.

The force by which the isolating interrupter is moved out of its first position into its second position can be produced for example by a spring element which is connected to the interrupter for this purpose or which acts on the interrupter. Alternatively, the force could also be applied by an intumescent material which expands when a certain temperature is reached and in this way moves the isolating interrupter out of its first position into its second position.

It was stated at the beginning that in the normal state of the surge suppressor the first end of the electrically conductive connecting element is connected in an electrically conductive manner to the first terminal of the overvoltage-limiting component. The contact-making between the end of the connecting element and the terminal of the overvoltage-limiting component can be made for example as pressure contact-making. To do this the connecting element can be pre-tensioned accordingly or can be pressed with a force, for example a spring force, against the terminal of the overvoltage-limiting component. When a critical state of the overvoltage-limiting component is reached, then the connection is broken by at least the first end of the electrically conductive connecting element being moved away from the terminal of the overvoltage-limiting component. A critical state of the overvoltage-limiting component can be ascertained for example by measuring the current or measuring the temperature.

Preferably, the connection is however made as a thermally breaking connection which breaks when the temperature of the overvoltage-limiting component exceeds a boundary temperature so that it is a thermal disconnector. As is conventional in the prior art, in the surge suppressor in accordance with the invention the thermally breaking connection is also preferably implemented by a soldered connection. If the overvoltage-limiting component, i.e., the surge arrester, has been heated up so dramatically by a continuous overload that a given boundary temperature is exceeded, the soldered connection between the terminal of the surge arrester and the conductive connecting element fuses. Moreover, the isolating interrupter is moved by a force, preferably by the force of at least one spring element, between the terminal of the surge arrester and the assigned end of the conductive connecting element.

According to a first preferred version of the surge suppressor in accordance with the invention, the isolating interrupter is movably located in a housing whose volume is greater than the volume of the interrupter, i.e., the interior of the housing is only partially filled by the isolating interrupter. The region within the housing in which the isolating interrupter is not located in the normal state of the surge suppressor forms the chamber into which an arc which arises when the electrical connection is broken between the first end of the electrically conductive connecting element and the first terminal of the overvoltage-limiting component is moved by the interrupter. Moreover, the housing which can consist of several parts has an opening through which in the normal state of the surge suppressor the first end of the electrically conductive connecting element is connected in an electrically conductive manner to the first terminal of the surge arrester.

In the surge suppressor in accordance with the invention, by the movement of the isolating interrupter out of its first position into its second position not only does the breaking of the connection between the conductive connecting element and the overvoltage-limiting component take place, but also a deflection of the arc into the chamber in the housing. When the connection between the first end of the electrically conductive connecting element and the first terminal of the surge arrester is broken, the plasma which is present in the region of the contacts is also forced into the chamber in the housing. To do this, the end of the isolating interrupter which is facing the first terminal of the overvoltage-limiting component can be made differently, for example it can have the shape of a wedge or of a funnel.

According to one configuration of the invention, the isolating interrupter has an opening through which in the normal state of the surge suppressor the first end of the electrically conductive connecting element is connected in an electrically conductive manner to the first terminal of the surge suppressor. The opening in the isolating interrupter is made correspondingly to the opening in the housing so that in the normal state of the surge suppressor the first end of the electrically conductive connecting element extends through the opening in the housing and the opening in the isolating interrupter and is preferably connected to the terminal of the surge arrester via the thermally breaking connection, for example a soldered connection.

In one preferred configuration of the surge suppressor in accordance with the invention, the housing in the region of the chamber has an outlet opening via which the plasma which has been forced by the interrupter into the housing can flow out. This advantageously leads to the plasma being able to escape in a controlled manner from the housing, as a result of which the risk of re-ignition of an arc is still further reduced. Moreover, the outlet opening in the housing ensures that the pressure in the housing does not become too great when the isolating interrupter moves out of its first position into its second position and in this way the plasma is forced into the housing. Thus damage of the housing is prevented. The outlet opening is located preferably in the wall of the housing toward which the interrupter is moving when it is moving out of its first position into its second position.

According to another especially advantageous configuration of the invention, in the isolating interrupter at least one channel is formed which is open on the side facing the chamber. The isolating interrupter is thus made as a type of hollow body. If the isolating interrupter is moved out of its first position into its second position after breaking of the connection between the first end of the electrically conductive connecting element and the first terminal of the overvoltage-limiting component, in doing so, as in a closed interrupter, an existing arc is forced into the chamber in the housing. In doing so, part of the plasma is also forced into the chamber in the housing, while another part of the plasma, oppositely to the direction in which the interrupter is moving, flows into the channel in the interrupter.

In this way, a conductive plasma is also effectively discharged from the region between the contacts which are opening.

According to one version of this configuration, within the housing a web or a partition is made which extends in the direction in which the isolating interrupter is moving so that the web or the partition divides the chamber in the housing into two component chambers. If the isolating interrupter is shifted out of its first position into its second position, the web or the partition dips into the channel in the isolating interrupter. In the isolating interrupter several channels and within the housing correspondingly several webs or partitions can also be made so that correspondingly several component chambers are made in the housing. The housing then has a comb-shaped structure.

If the isolating interrupter has a least one channel into which plasma can flow when the interrupter is moving out of its first position into its second position, the interrupter preferably has at least one outlet opening through which plasma can flow out of the isolating interrupter. The outlet opening can be made for example on the side facing away from the chamber in the isolating interrupter. The channel which has formed in the interrupter is thus connected via the outlet opening to the interior of the housing, the housing preferably likewise having an outlet opening. The latter can be located opposite the outlet opening in the interrupter or also on another side wall. In this configuration of the surge suppressor plasma can flow through the channel in the interrupter opposite the direction in which the isolating interrupter is moving and can escape in a controlled manner from the housing via the outlet opening in the housing.

Between the inside wall of the housing and the outside surface of the isolating interrupter an outlet channel can be formed through which plasma can flow out of the channel in the interrupter through the outlet opening in the interrupter to the outlet opening in the housing. In order to further increase the cooling of the hot plasma, in the outlet channel there can be a medium for cooling of the discharging plasma which is also preferably used for damping the flow of the plasma. Here it can be for example a material with a honeycomb structure which has high porosity. Likewise, it can be a grainy material, for example, sand or gravel.

In the version in which the isolating interrupter is located movably in a housing, the isolating interrupter and the housing are matched to one another such that the cross section of the interior of the housing is only slightly larger than the cross section of the interrupter. This leads to only relatively narrow gaps in which the arc can propagate between the inside wall of the housing and the outside surfaces of the isolating interrupter. This leads to an increase of the pressure in the gaps; this in turn leads to an increase of the arc voltage. If moreover the housing and/or the isolating interrupter consists at least in segments of a material which evolves gas, this moreover leads to the arc in the gap between the isolating interrupter and the inside wall of the housing being blown out by discharging material and thus being cooled. This also promotes the intended quenching of the arc.

So that the housing and the isolating interrupter reliably withstand the high temperatures or high pressures which occur under certain circumstances, the housing and preferably also the isolating interrupter consist of a mechanically and thermally stable material, preferably of a fiber-reinforced material.

The matching of the interior of the housing to the cross section of the interrupter moreover leads to the isolating interrupter being routed out of its first position into its second position in the housing as it moves. Moreover, between the isolating interrupter and the inside wall of the housing a guide can be formed, for example in the form of guide ribs and guide grooves which are made correspondingly to one another on the isolating interrupter or in the housing.

As has been described above, the surge suppressor in accordance with the invention has at least one isolating interrupter which can be made accordingly. According to one configuration of the invention, the surge suppressor has not only one interrupter, but several isolating interrupters which are each located to be able to move relative to the first terminal of the overvoltage-limiting component and are preferably exposed to a force by which they can each be moved out of a first position into a second position.

If the surge suppressor has several isolating interrupters, it is preferably provided that each interrupter is located movably in a housing or a housing segment, each housing or each housing segment having an opening and the openings being arranged to one another such that in the normal state of the surge suppressor the first end of the electrically conductive connecting element is connected in an electrically conductive manner through the openings to the first terminal of the surge arrester. The individual isolating interrupters thus form a type of series circuit so that the individual interrupters are moved into their second position after the connection is broken; in this second position the interrupters are located between the first end of the electrically conductive connecting element and the first terminal of the overvoltage-limiting component. If the surge suppressor has for example two isolating interrupters, in the broken state of the connection the two isolating interrupters are located between the first end of the electrically conductive connecting element and the first terminal of the surge arrester.

In the normal state of the surge suppressor, there are preferably at least two isolating interrupters essentially on different sides of the first terminal of the overvoltage-limiting component such that the directions in which these interrupters are moving are opposite one another. Essentially on different sides of the first terminal means here that at least the greater part of the isolating interrupters are located on different sides. A smaller part of the isolating interrupters can thus also be located on the same side of the first terminal, for example when in the interrupters one opening at a time is formed through which in the normal state of the surge suppressor the first end of the connecting element extends to the first terminal. In the normal state these interrupters thus extend on both sides of the first terminal, but the greater part being located on one side of the terminal.

If the surge suppressor has two isolating interrupters, this means, for example, that in the normal state of the surge suppressor the first interrupter is located on the left side of the terminal and the second interrupter is located on the right side of the terminal of the overvoltage-limiting component. When the connection is broken, the first interrupter is then moved within its housing from left to right and the second interrupter within its housing is moved from right to left. This leads to the length of the arc which forms when the thermal connection is broken becoming larger and the plasma being forced by the isolating interrupters in opposite directions into two chambers.

The advantageous configurations of the interrupter and of the housing which were described above in conjunction with an isolating interrupter can also be implemented when the surge suppressor has several isolating interrupters and several housings or several housing segments. For example, in the housings or in the housing segments one outlet opening at a time can be made so that plasma can escape in a controlled manner from the housing through the outlet openings in different directions. The individual housings are preferably located immediately adjacent to one another so that the interiors of the housings are each separated from one another by a partition, the partition being interrupted by the opening for the first end of the electrically conductive connecting element. The individual housings can also be joined tightly to one another to form a common housing so that one housing has several housing segments in which one corresponding chamber at a time is then made for the individual interrupters.

According to another version of the surge suppressor in accordance with the invention, in the isolating interrupter at least one channel is made which acts as a chamber into which an arc, which forms when the thermal connection occurs, can be moved. The channel is open on the side which faces the first terminal of the overvoltage-limiting component and the isolating interrupter can be moved relative to the first terminal of the overvoltage-limiting component such that the first end of the electrically conductive connecting element in the second position of the isolating interrupter is located in the channel in the interrupter.

In this configuration of the surge suppressor in accordance with the invention, the isolating interrupter in its second position is thus not as a whole between the first terminal of the overvoltage-limiting component and the first end of the electrically conductive connecting element, but the isolating interrupter is pushed with its channel over the first end of the electrically conductive connecting element. The first end of the conductive connecting element is then separated from the first terminal of the overvoltage-limiting component by a lower wall which borders the channel. When the isolating interrupter is moving past the first terminal of the overvoltage-limiting component, an existing arc is forced into the channel which acts as the chamber, as a result of which the length of the arc between the first terminal of the overvoltage-limiting component and the first end of the conductive connecting element increases; this generally leads to quenching of the arc. In addition, an outflow of the plasma which is forming in the region between the contacts from the active region between the contacts is also effected. In doing so the isolating interrupter can additionally have at least one outlet opening through which plasma can flow out of the channel in the interrupter.

According to one development of this version, on the side of the first terminal of the overvoltage-limiting component on which the isolating interrupter is not located in the normal state of the surge suppressor, there is a sealing element which is adjoined by the isolating interrupter in its second position with the open side of the channel. If the isolating interrupter is in its second position, the open side of the channels is thus sealed by the sealing element so that an arc which may possibly still be present is “pinched off” or “cut off”. In the second position of the isolating interrupter then the first end of the electrically conductive connecting element is completely encapsulated so that re-ignition of an arc between the connecting element and the first terminal of the surge arrester cannot occur. The sealing element has a continuous opening through which the conductive connecting element extends so that the sealing element is also used as a holder for the connecting element.

If, in the surge suppressor in accordance with the invention, the overvoltage-limiting component has a projecting first terminal, according to another configuration of the version described last it is provided that in the isolating interrupter a second channel is formed which runs parallel to the first channel. The second channel is made such that when the isolating interrupter is moving out of its first position into its second position, the interrupter is pushed with its second channel over the projecting terminal of the surge arrester. In the second position of the isolating interrupter then the first end of the electrically conductive connecting element is located in the first channel and the terminal of the surge arrester is located in the second channel. The terminal and the connecting element are thus surrounded by the isolating interrupter, the terminal and the connecting element being located in different channels in the interrupter so that they are separated and electrically isolated from one another.

So that the isolating interrupter can be shifted relative to the first terminal which preferably projects perpendicularly from the surge arrester, the bottom of the isolating interrupter which faces the surge arrester is open in the region of the second channel or the second channel in its bottom has a slot which runs in the direction of motion and into which the terminal can slide.

The second channel, in the same manner as the first channel, can be open on the side facing the first terminal of the overvoltage-limiting component, then the isolating interrupter in its first position being located next to the terminal of the overvoltage-limiting component in the direction in which the interrupter is moving. In this version there are preferably two sealing elements such that the open side of the two channels is sealed by one sealing element at a time when the isolating interrupter is in its second position.

Alternatively, the isolating interrupter can also be made such that the first terminal of the overvoltage-limiting component is located in the second channel in the first position of the interrupter, the first end of the electrically conductive connecting element making contact with the first terminal of the overvoltage-limiting component. For this purpose, the first chamber has a smaller length than the second chamber so that in the first position of the isolating interrupter the first chamber is located next to the first end of the electrically conductive connecting element in the direction in which the interrupter is moving, while the first terminal of the overvoltage-limiting component is located in the second channel.

In the configuration of the surge suppressor in which two channels are made in the isolating interrupter, preferably on the side of the first terminal of the overvoltage-limiting component on which the isolating interrupter is not located in the normal state of the surge suppressor, there is also at least one sealing element which is adjoined by the isolating interrupter in its second position with the open side of the channel.

According to another advantageous configuration, the isolating interrupter has at least one outlet opening, preferably in the back wall of the second channel, which in the first position of the isolating interrupter is spaced apart from the first terminal of the overvoltage-limiting component so that plasma can flow out of the interior of the corresponding channel in a controlled manner through the outlet opening. This prevents an overly great pressure from forming in the channel of the isolating interrupter when the isolating interrupter is in its second position in which the open side of the channel is closed by the sealing element.

In the above described exemplary embodiments of the surge suppressor in accordance with the invention, the isolating interrupter or the isolating interrupters are made as slides so that the interrupter or interrupters are moved linearly out of the first position into the second position.

In particular, there are a host of possibilities for configuring and developing the surge suppressor in accordance with the invention as will be apparent from the following description of preferred exemplary embodiments in conjunction with the accompanying drawings.

### BRIEF DESCRIPTION OF THE DRAWINGS

FIGS. 1a-1c show schematics of a first exemplary embodiment of a surge suppressor in accordance with the invention, from the side, in three different states,

FIGS. 2a & 2b show two versions of an isolating interrupter and of a housing which accommodates the interrupter, from the side,

FIGS. 3a-3c show three versions of an isolating interrupter and of a housing which accommodates the interrupter, from the top,

FIGS. 4a & 4b show two versions of an isolating interrupter and of a housing which accommodates the interrupter, seen in the same direction as in FIGS. 1a-1c,

FIGS. 5a-5c show schematics of one version of the exemplary embodiment of a surge suppressor in accordance with the invention shown in FIGS. 1a-1c, with two isolating interrupters, in three different states,

FIGS. 6a-6c show schematics of a second exemplary embodiment of a surge suppressor in accordance with the invention, in three different states,

FIGS. 7a-7c show schematics of another exemplary embodiment of a surge suppressor in accordance with the invention, in three different states,

FIGS. 8a-8c show schematics of a fourth exemplary embodiment of a surge suppressor in accordance with the invention, in three different states,

FIGS. 9a-9c show schematics of the surge suppressor according to FIGS. 8a-8c, in a plan view, in three different states,

FIGS. 10a-10c show schematics of a fifth exemplary embodiment of a surge suppressor in accordance with the invention, in three different states,

FIGS. 11a-11c show schematics of the surge suppressor according to FIG. 10, in a plan view, in three different states,

FIGS. 12a-12c show schematics of another exemplary embodiment of a surge suppressor in accordance with the invention, in three different states, and

FIGS. 13a-13c show schematics of another exemplary embodiment of a surge suppressor in accordance with the invention, in three different states.

### DETAILED DESCRIPTION OF THE INVENTION

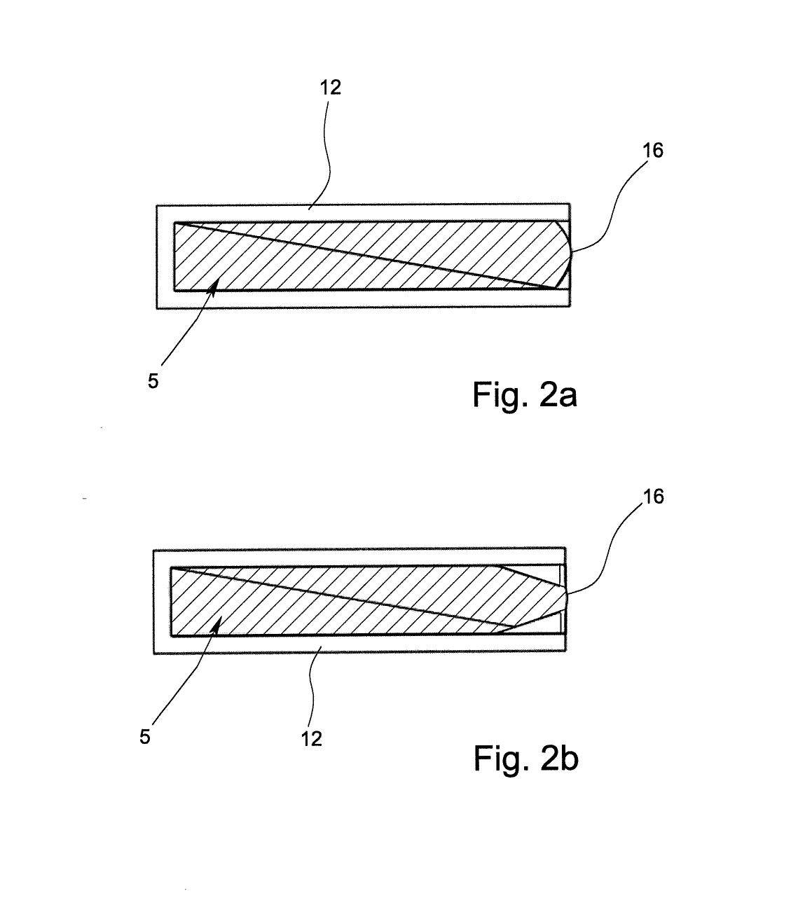

The figures show schematics of different exemplary embodiments of a surge suppressor 1 with a housing 2 which is shown only partially in the figures and in which there is a varistor 3 as the overvoltage-limiting component. Moreover, the surge suppressor 1 has another electrically conductive connecting element 4 and at least one isolating interrupter 5, of which different versions are shown in FIGS. 2a to 4b.

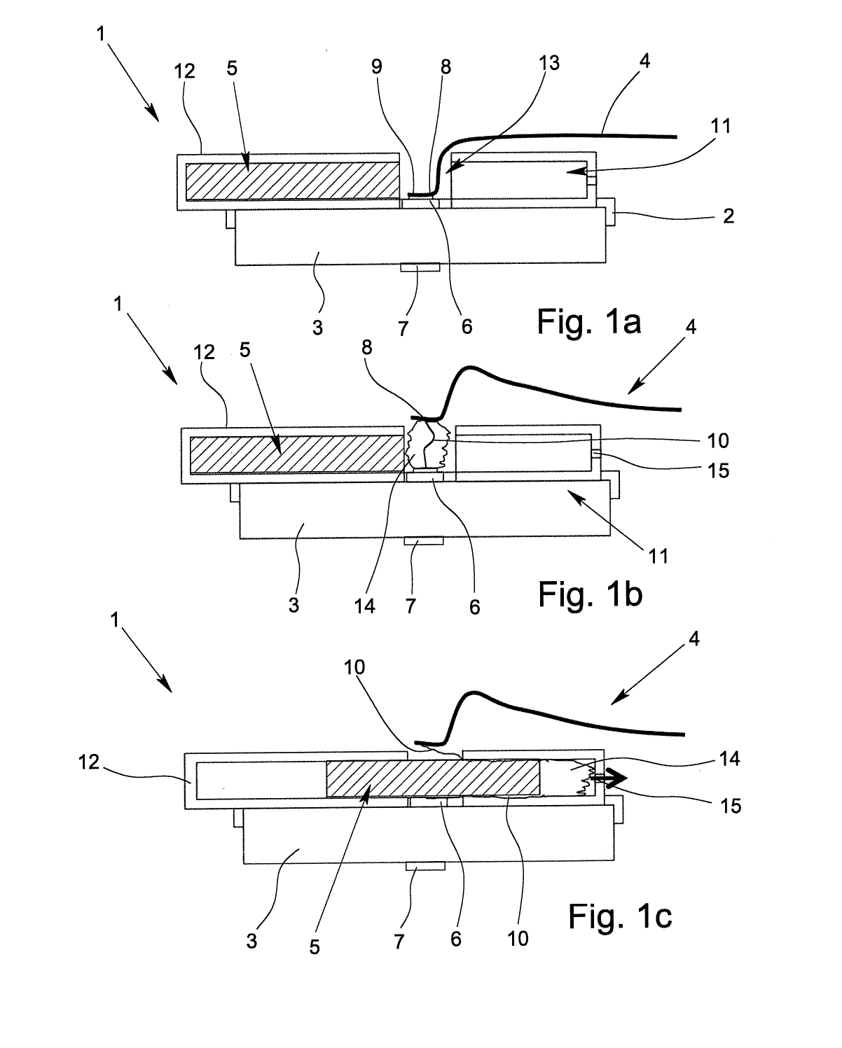

The varistor 3 has a first terminal 6 and a second terminal 7 which are connected in an electrically conductive manner to the terminal contacts of the surge suppressor 1 which are not shown here, when the surge suppressor 1 is in the normal state, i.e., is not disconnected. In the normal state of the surge suppressor 1 which is shown in FIG. 1a, the first terminal 6 of the varistor 3 is connected to the first end 8 of the electrically conductive connecting element 4 via a thermally breaking connection. In the exemplary embodiments shown, the thermally breaking connection is made as a soldered connection 9 which then breaks when the temperature of the varistor 3 has reached a boundary value. The isolating interrupter 5 is held in its first position by the soldered connection 9 which is present in the normal state of the surge suppressor 1 against a force which acts on the interrupter 5 and which can be produced for example by a spring element.

If unallowable heating of the varistor 3 occurs, this leads to a softening of the soldered connection 9; this first leads to the first end 8 of the connecting element 4 moving away from the first terminal 6 of the varistor 3. This can be achieved for example by the connecting element 4 itself being elastic and being deflected out of its relieved state when it is connected to the terminal 4 via the soldered connection 9. Alternatively, however, force which is directed away from the soldered connection 9 can also act on the connecting element 4. Moreover, the isolating interrupter 5 is moved out of its first position in the direction of its second position, as is shown in FIG. 1c. In this way the movement of the first end 8 of the connecting element 4 away from the first terminal 6 of the varistor 3 can also be supported. In the surge suppressor 1 in accordance with the invention the isolating interrupter 5 is at this point made such that it forces an arc 10 which arises when the connection 9 between the first end 8 of the connecting element 4 and the terminal 6 of the varistor 3 is broken into at least one partially closed chamber 11.

FIGS. 2a to 6c show various exemplary embodiments of a surge suppressor 1 in accordance with the invention in which the isolating interrupter 5 is movably located in a housing 12 whose volume is greater than the volume of the interrupter 5 so that the housing 12 is only partially filled by the interrupter 5. The housing 12 has one opening 13 through which in the normal state of the surge suppressor 1 the first end 8 of the electrically conductive connecting element 4 is electrically conductively connected to the first terminal 6 of the varistor 3 via the soldered connection 9, as is apparent for example from FIG. 1a.

In the exemplary embodiment which is shown in FIGS. 1a-1c, the isolating interrupter 5, in the normal state of the surge suppressor 1—relative to the first terminal 6 of the varistor 3—is on the left side within the housing 12, while the right side of the housing 12 surrounds the chamber 11 into which, when the soldered connection 9 is broken, an arc 10 existing between the terminal 6 and the connecting element 4 is forced by the isolating interrupter 5. As is apparent from FIG. 1c, this leads to a distinct lengthening of the arc 10, as a result of which the arc 10 is quenched. Moreover, since the plasma 14 has also been forced out of the active region between the contacts, i.e., between the first terminal 6 of the varistor 3 and the first end 8 of the connecting element 4, an otherwise possible re-ignition of an arc between the contacts is also prevented.

FIG. 1b schematically shows the state when the soldered connection 9 has broken and the end 8 of the connecting element 4 has been disconnected from the terminal 6 of the varistor 3. Here the arc 10 is also shown which extends between the end 8 of the connecting element 4 and the terminal 6 of the varistor 3, as is the plasma 14 which forms in the region between the end 8 of the connecting element 4 and the terminal 6 of the varistor 3. The isolating interrupter 5 is shown still in the first position even if a movement of the interrupter 5 into the second position, i.e., as shown in FIG. 1c to the right, is already beginning, when the soldered connection 9 breaks.

So that when the isolating interrupter 5 is moving out of its first position into its second position the pressure within the chamber 11 in the housing 12 does not become too great, the housing 12 has at least one outlet opening 15 through which the plasma 14 can flow out in a controlled manner, as is indicated in FIG. 1c by an arrow. In this way, damage to the housing 12 by an overly high pressure or an overly high temperature caused by the plasma 14 which has been deflected into the chamber 11 is prevented. The outlet opening 15 is located preferably in the wall of the housing 12 towards which the interrupter 5 is moving when it is being shifted into its second position. Alternatively, or additionally, an outlet opening can be made also in the other walls of the housing 12 which surround the chamber 11.

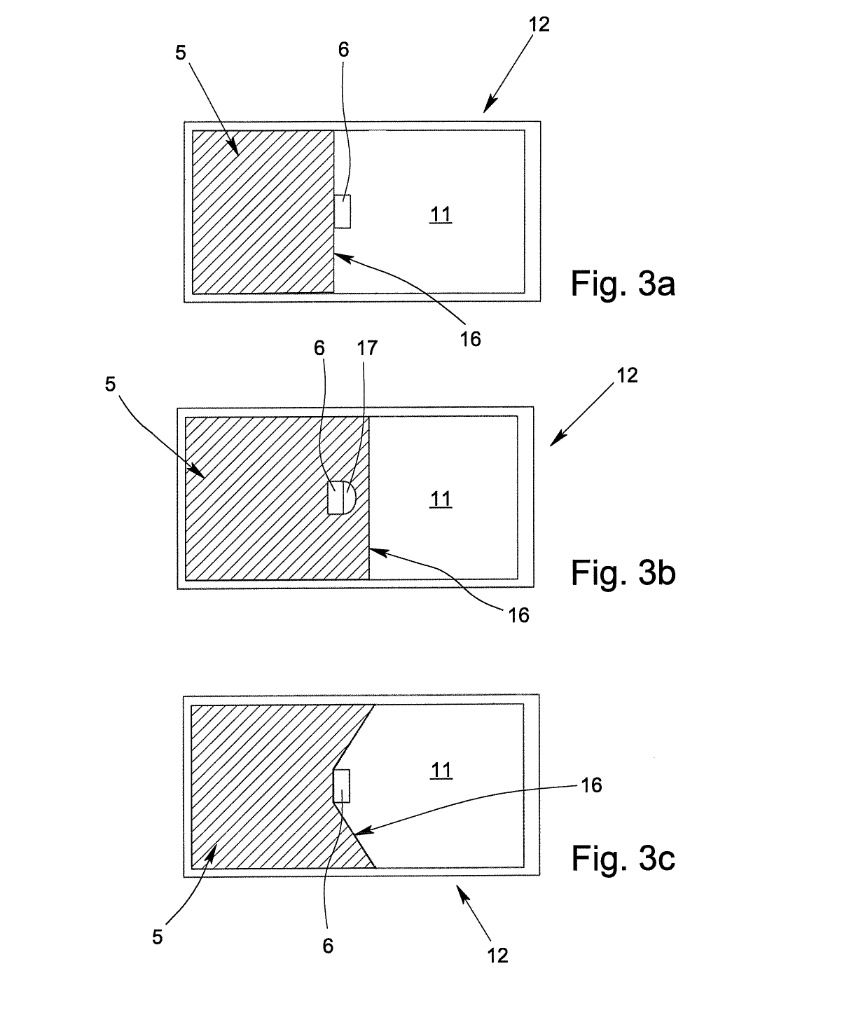

FIGS. 2a to 4b show different versions of the isolating interrupter 5 and of the housing 12 in which the interrupter 5 is guided. FIGS. 2a-2b show the housing 12 and the interrupter 5, as also in FIG. 1, from the side, one side wall of the housing 12 being omitted so that the interrupter 5 which is located in the housing 12 is visible. FIG. 3 shows the housing 12 and the interrupter 5 in a plan view, here the top of the housing 12 being omitted so that the interrupter 5 is in turn visible.

According to FIGS. 2a and 2b, the end 16 of the isolating interrupter 5 which faces the first terminal 6 of the varistor 3 and the first end 8 of the connecting element 4 in the normal state of the surge suppressor 1 can be made arched or wedge-shaped. As is apparent from the plan view according to FIG. 3c, the end 16 of the interrupter 5 can also be made funnel-shaped. Likewise, the end 16 of the isolating interrupter 5 can also be made straight, as is shown in FIGS. 3a and 3b. In the exemplary embodiment shown in FIG. 3b, the isolating interrupter 5 has an opening 17 through which, in the normal state of the surge suppressor 1, the first end 8 of the electrically conductive connecting element 4 is connected via the soldered connection 9 to the first terminal 6 of the varistor 3. For purposes of explanation, the first terminal 6 of the varistor 3 which is located under the corresponding opening 13 in the housing 12 is also shown here.

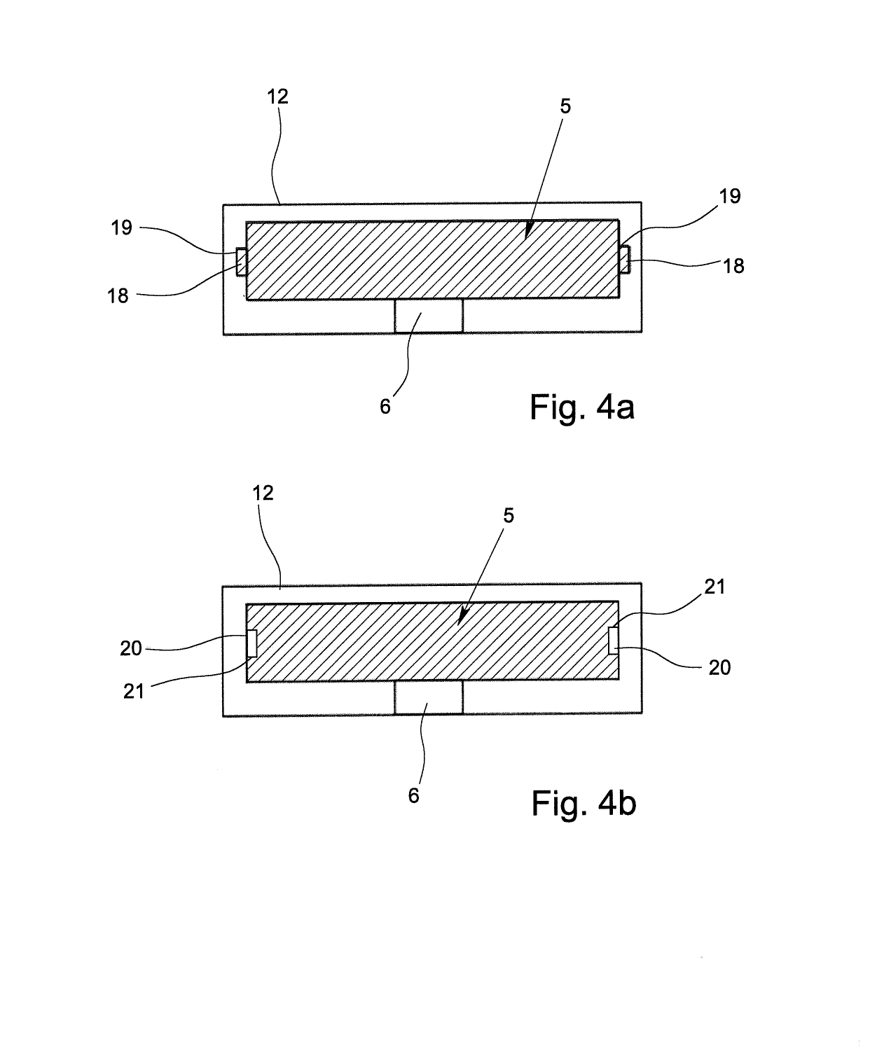

It is apparent from the two representations according to FIGS. 4a & 4b, each of which show one version of the isolating interrupter 5 and of the housing 12 from the direction of the chamber 11, that the isolating interrupter 5 and the housing 12 are matched to one another such that the cross section of the interior of the housing 12 is only slightly larger than the cross section of the interrupter 5. This leads to an only relatively narrow gap in which the arc 10 can propagate remaining between the inside wall of the housing 12 and the top and the bottom of the isolating interrupter 5, as is shown in FIG. 1c. Moreover, this leads to the interrupter 5 being guided in the housing 12 as it moves out of the first position into the second position. To improve the guidance, the isolating interrupter 5, according to FIG. 4a, can have guide ribs 18 and corresponding guide grooves 19 in the inside wall of the housing 12. Alternatively, according to FIG. 4b, guide ribs 20 can be made on the inside wall of the housing 12 and corresponding guide grooves 21 can be made in the isolating interrupter 5.

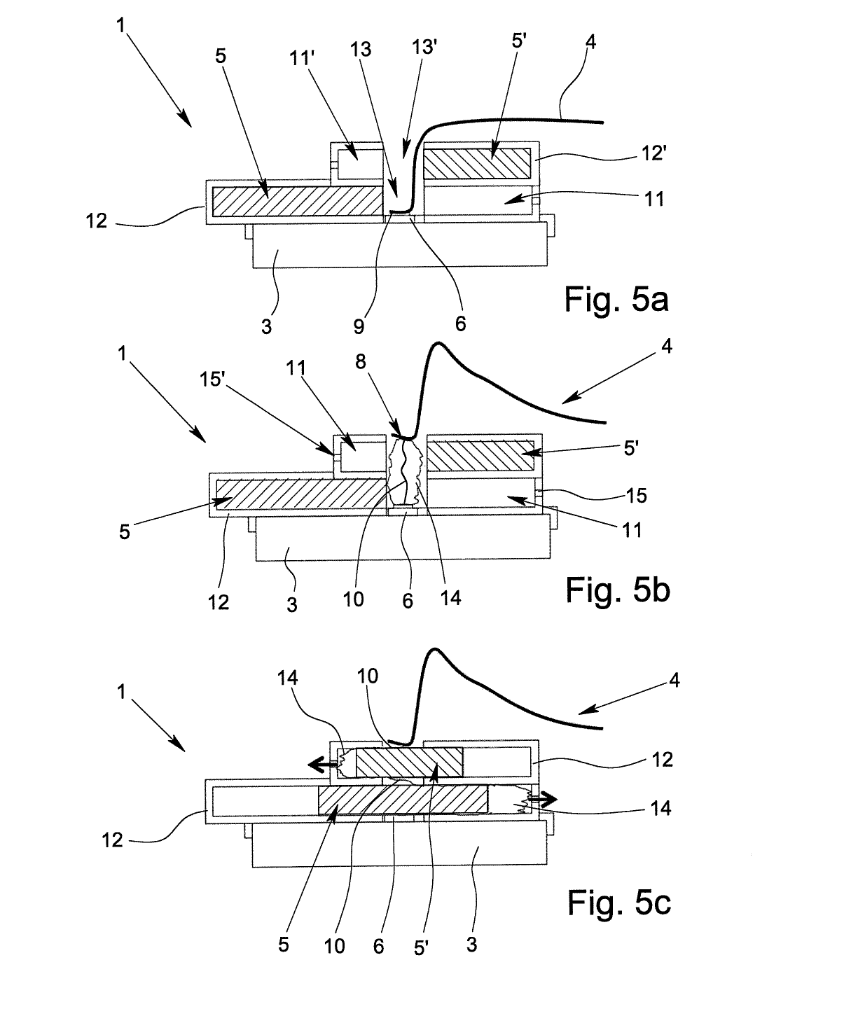

FIGS. 5a-5c show a schematic of one version of the surge suppressor 1 which is shown in FIG. 1, in turn in three different states. While there is only one isolating interrupter 5 in the surge suppressor 1 according to FIGS. 1a-1c, the surge suppressor 1 according to FIGS. 5a-5c has two isolating interrupters 5, 5′ which are each movably guided in a housing 12, 12′. The two housings 12, 12′ each have an opening 13, 13′, the two openings 13, 13′ being located on top of one another, i.e., aligned with one another so that, in the normal state of the surge suppressor 1, the first end 8 of the conductive connecting element 4 is connected in an electrically conductive manner to the first terminal 6 of the varistor 3 via the soldered connection 9 through the two openings 13 13′.

As is apparent from FIG. 5a, the two isolating interrupters 5, 5′, in the normal state of the surge suppressor 1, are located on different sides of the first terminal 6 of the varistor 3. Corresponding thereto, the chambers 11, 11′ in two housings 12, 12′ are also on different sides of the first terminal 6 of the varistor 3 so that the directions of movement of the two interrupters 5, 5′ are also opposite one another. As is apparent from FIG. 5c, the first, lower interrupter 5 moves from left to right within the housing 12 when the soldered connection 9 is broken, while the second, upper interrupter 5′ is moved within its housing 12′ from right to left. The two isolating interrupters 5, 5′ thus act like two slides in opposite directions so that the length of the arc 10 which forms when the soldered connection 9 is broken is further increased, and the plasma 14 is forced by the two isolating interrupters 5, 5′ in opposite directions into the two chambers 11, 11′ in the two housings 12, 12′. Via outlet openings 15, 15′ on the ends of the housing 12, 12′, the plasma 14 can in turn escape in a controlled manner, the outlet openings 15, 15′ also being made on different sides.

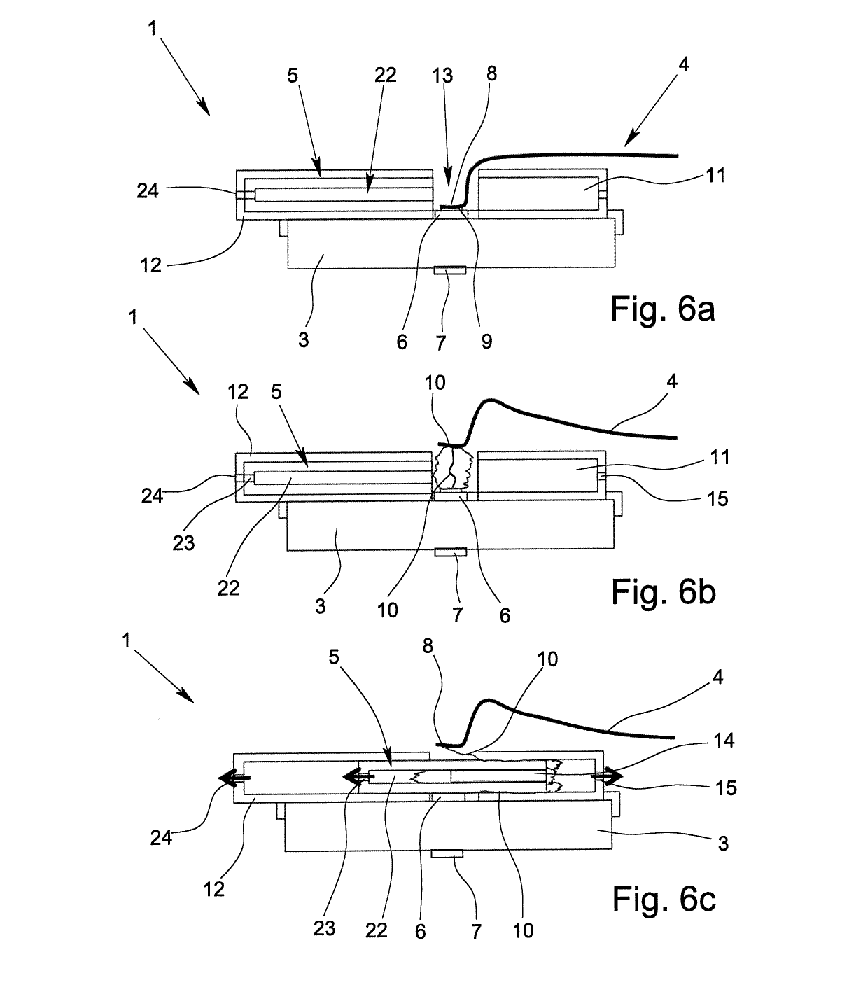

FIGS. 6a-6c are schematic views of another exemplary embodiment of a surge suppressor 1 in accordance with the invention. In this embodiment, in the isolating interrupter 5, a channel 22 is provided which is open on the side which faces the chamber 11 and the first terminal 6 of the varistor 3. If the isolating interrupter 5 is moved out of its first position (FIG. 6a) in the direction of its second position (FIG. 6c) after breaking of the soldered connection 9, an existing arc 10 is forced into the chamber 11 in the housing 12. In addition, the plasma 14 is also first forced into the chamber 11, but part of the plasma 14 also flows into the channel 22 in the interrupter 5 in a direction opposite to the direction in which the interrupter 5 is moving. The plasma 14 can flow out of the channel 22 into the housing 12 through an outlet opening 23 which has been made in the isolating interrupter 5 on the side facing away from the chamber 11. Through a second outlet opening 24 which is made in the housing 12 and which is formed on the side of the housing 12 opposite the first outlet opening 15, the plasma 14 can then also escape from the housing 12 in the direction opposite the direction in which the interrupter 5 is moving.

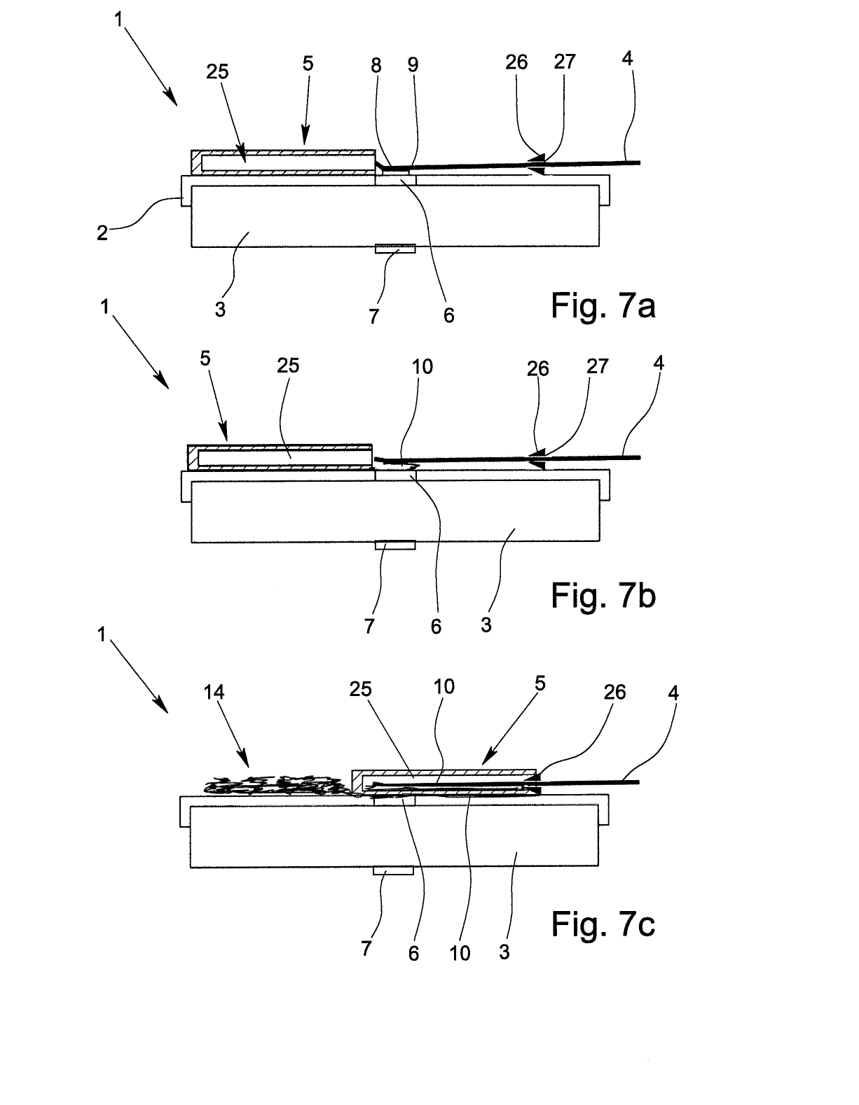

In the other exemplary embodiment according to FIGS. 7a-7c, in the isolating interrupter 5, a channel 25 is formed which acts as a chamber into which an arc 10 which forms when the soldered connection 9 is broken can be moved. On the side of the interrupter 5 which faces the first terminal 6 of the varistor 3, the channel 25 is open so that the interrupter 5 is pushed with its channel 25, which is open on one side, over the first end 8 of the conductive connecting element 4 when the interrupter 5 moves out of its first position (FIG. 7a) into its second position (FIG. 7c). The connecting element 4 is then separated from the first terminal 6 of the varistor 3 by the lower wall which borders the channel 25. In this version, part of the electrically conductive connecting element 4, in particular its first end 8, is surrounded by the isolating interrupter 5 when the interrupter 5 is in its second position. Here too an arc 10 which forms when the soldered connection 9 is broken is moved by the interrupter 5 into the chamber 11 which has been formed by the channel 25; this leads first of all to an increase in the length of the arc 10.

As is also apparent from FIGS. 7a-7c, on the side of the first terminal 6 of the varistor 3 on which the isolating interrupter 5 is not located, in the normal state of the surge suppressor 1, there is a sealing element 26 which is adjoined by the isolating interrupter 5 in its second position with the open side of the channel 25. In the second position of the interrupter 5, the channel 25, which is open on one side, is then sealed by the sealing element 26, as a result of which an arc 10 which possibly still exists is “pinched off” or “cut off” so that the arc 10 at latest then extinguishes. The sealing element 26 has a continuous opening 27 through which the connecting element 4 is routed so that the sealing element 26 is also used as a holder for the connecting element 4.

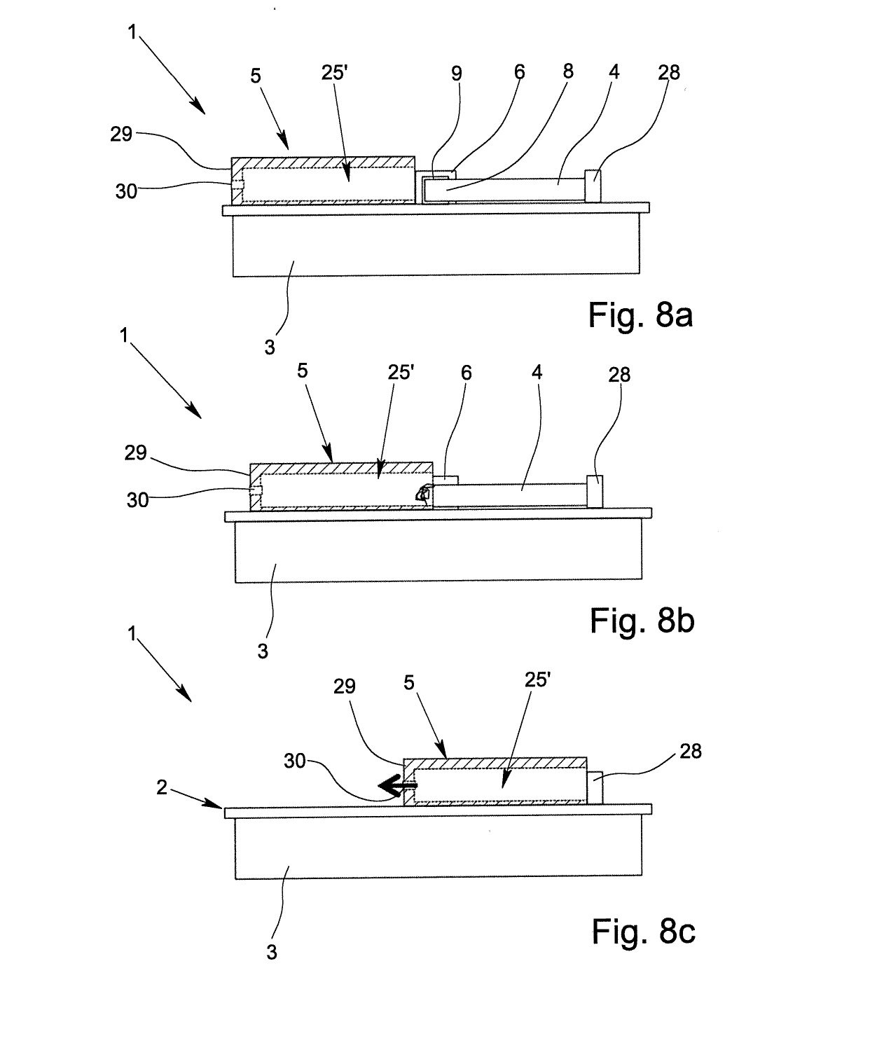

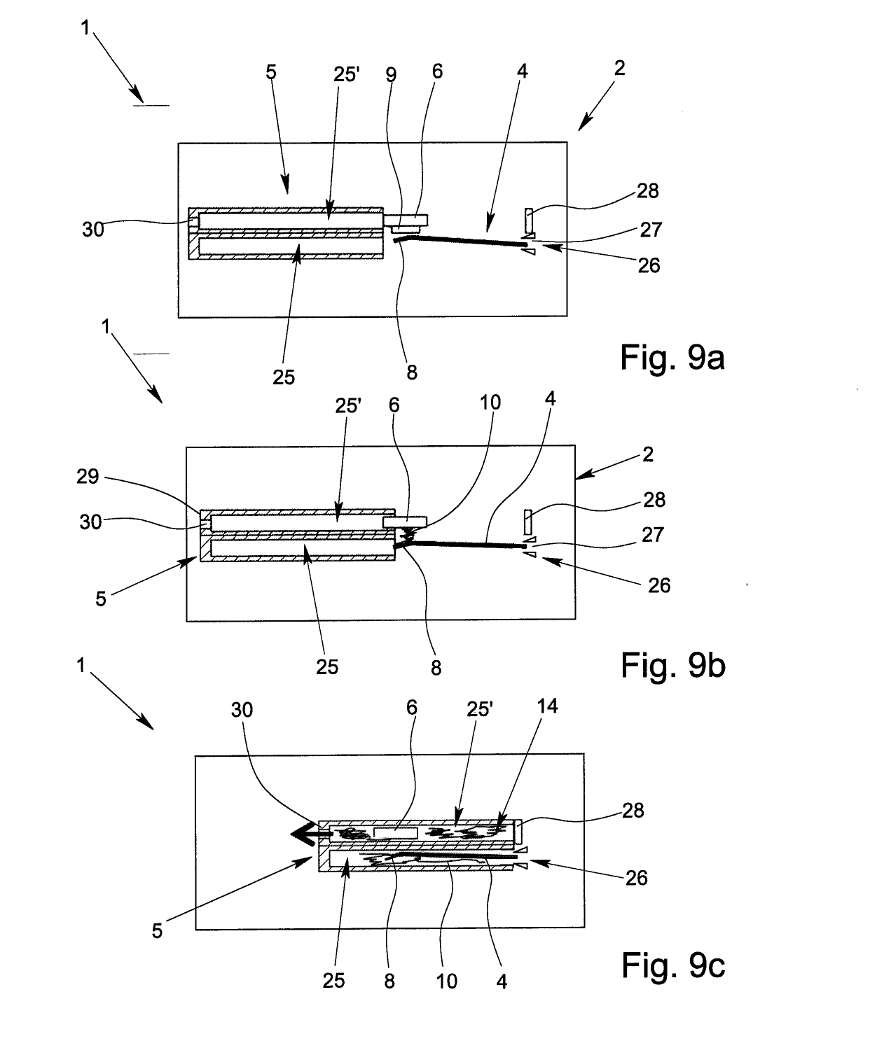

FIGS. 8a-8c and 9a-9c show other exemplary embodiments of a surge suppressor 1 in accordance with the invention, the isolating interrupter 5 having two channels 25, 25′ which run parallel to one another. The two channels 25, 25′ are open on the side which faces the first terminal 6 of the varistor 3 so that in the second position of the isolating interrupter 5, the first end 8 of the connecting element 4 is located in the first channel 25 and the first terminal 6 of the varistor 3 is located in the second channel 25′ of the interrupter 5. In contrast to the exemplary embodiment as shown in FIGS. 7a-7c, in which the first terminal 6 of the varistor 3 is made flat on one side of the varistor 3, in the surge suppressor 1 as shown in FIGS. 8a-8c and 9a-9c, the first terminal 6 projects essentially perpendicularly from the varistor 3. So that the isolating interrupter 5 can be moved relative to the projecting first terminal 6, the bottom of second channel 25′ which faces the varistor 3 has a slot which runs in the direction in which the interrupter 5 moves and in which the terminal 6 can slide out of the first position into its second position when the interrupter 5 is being moved.

In addition to the sealing element 26 for the first channel 25, there is a second sealing element 28 as a termination for the second channel 25′ in the second position of the interrupter 5. In the second position of the interrupter 5 the two channels 25, 25′ are thus sealed or closed by the two sealing elements 26, 28. Moreover, in the back wall 29 of the isolating interrupter 5, which wall is opposite the open side of the second channel 25′, an outlet opening 30 is made through which plasma 14 can flow in a controlled manner out of the channel 25′.

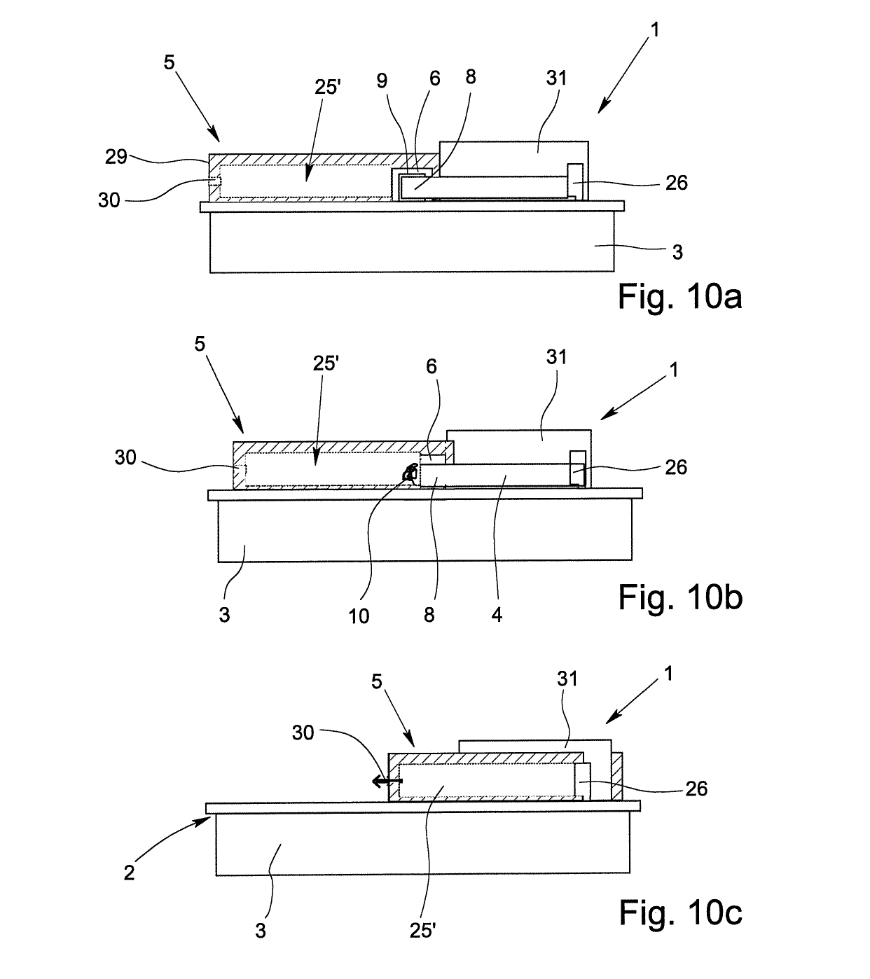

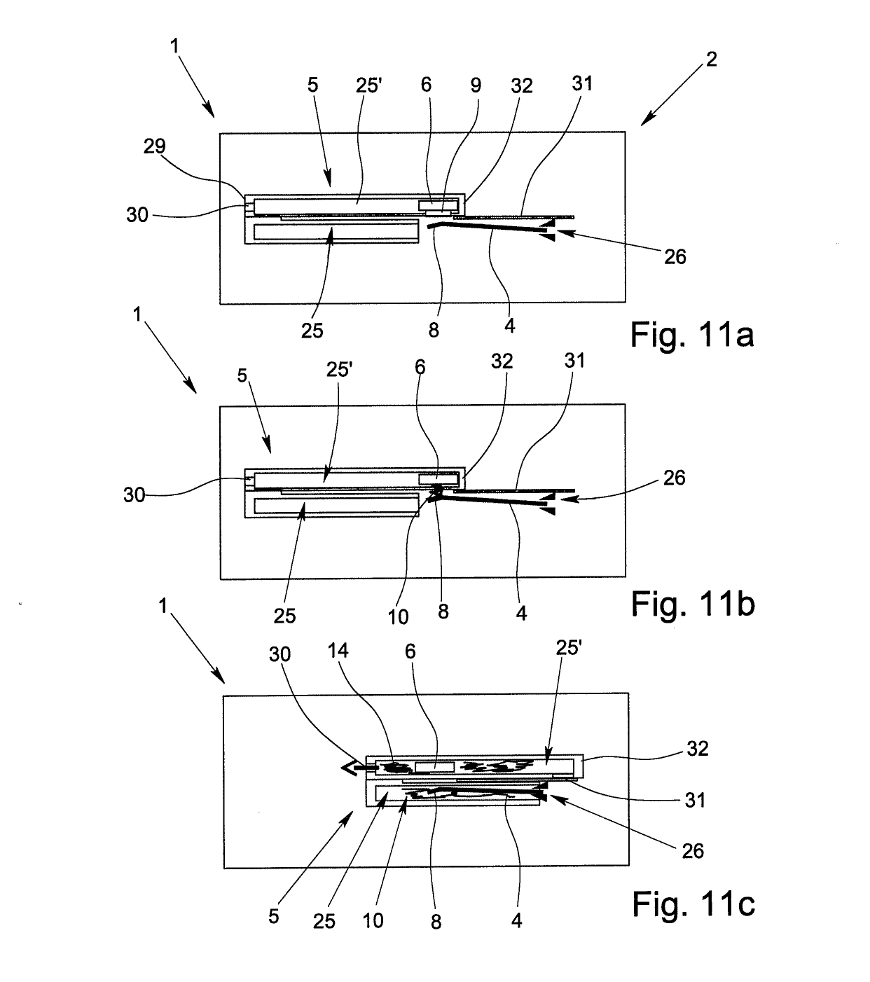

FIGS. 10a-10c and 11a-11c show a version of the above described exemplary embodiment of the surge suppressor 1 in accordance with the invention shown in FIGS. 8a-8c and 9a-9c and in which the first terminal 6 projects essentially perpendicularly from the varistor 3 and the isolating interrupter 5 likewise has two channels 25, 25′ which run parallel to one another. In this exemplary embodiment, the first terminal 6 of the varistor 3 in the first position of the isolating interrupter 5 is partially surrounded by the second channel 25′, as is apparent from FIG. 11a. For this purpose, the second channel 25′ has a greater length than the first channel 25 which is open on the side which faces the terminal 6 of the varistor 3. In the first position of the isolating interrupter 5, thus, the first channel 25 is to the left next to the first end 8 of the connecting element 4.

In the second position of the isolating interrupter 5, according to FIG. 11c, then the first end 8 of the connecting element 4 is in the first channel 25 while the first terminal 6 of the varistor 3 is in the second channel 25′. The two channels 25, 25′ are separated from one another by a longitudinal wall of the first channel 25 and an additional wall 31, the additional wall 31 in the same manner as the first terminal 6 of the varistor projecting essentially perpendicularly from the varistor 3 or from the housing 2 which surrounds the varistor 3.

In this exemplary embodiment, since the second channel 25′ has a second back wall 32, there is only one sealing element 26 as a termination for the first channel 25 in the second position of the interrupter 5. In the second position of the interrupter 5, the two channels 25, 25′ are likewise closed or sealed in this way. Moreover, in the back wall 29 of the second channel 25′ which is spaced apart from the first terminal 6 of the overvoltage-limiting component 3 in the first position of the isolating interrupter 5, an outlet opening 30 is provided through which plasma 14 can flow out of the channel 25′ in a controlled manner.

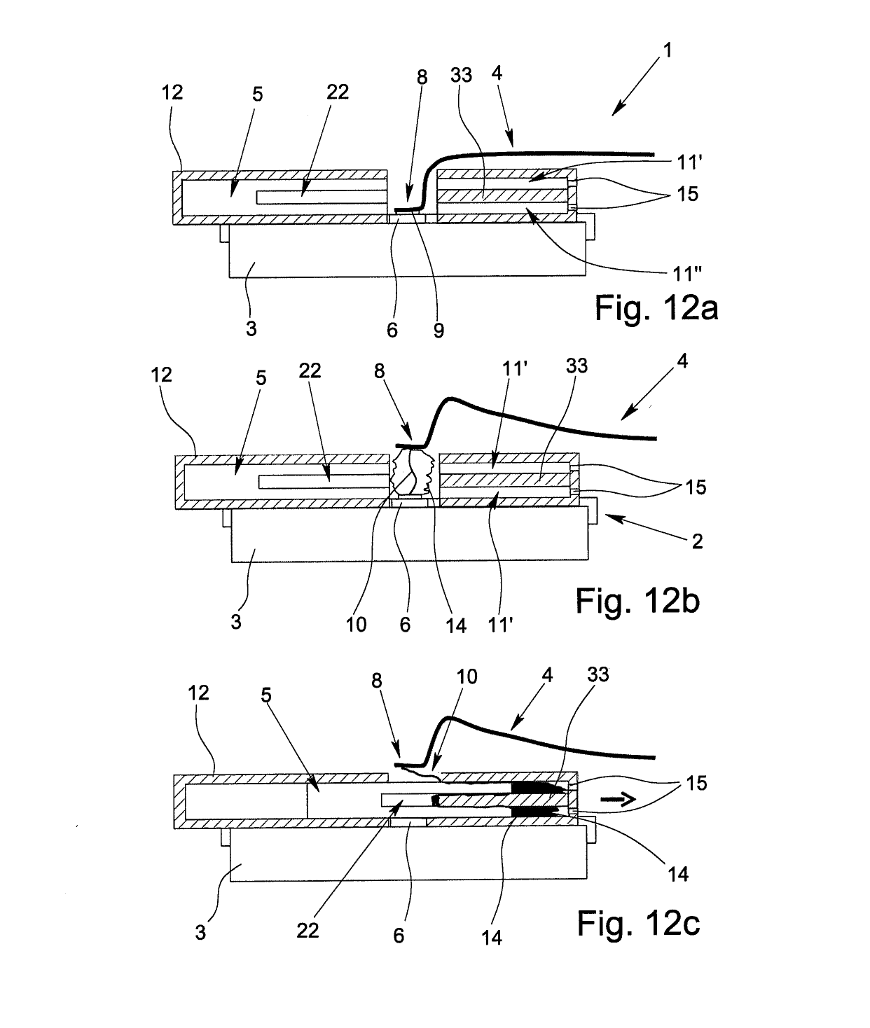

FIGS. 12a-12c show another exemplary embodiment of a surge suppressor 1 in accordance with the invention, which is a version of the exemplary embodiment shown in FIGS. 6a-6c. In this exemplary embodiment, a channel 22 is provided in the isolating interrupter 5 which is open on the side facing the first terminal 6 of the varistor 3. On the other side of the housing 12, a partition 33 is provided in the housing 12 so that the chamber 11 is divided into two component chambers 11′, 11″. The partition 33 is slightly thinner than the channel 22 in the isolating interrupter 5 so that the partition 33 slides into the channel 22 when the isolating interrupter 5 moves out of its first position into its second position.

If the isolating interrupter 5 is moved out of its first position (FIG. 12a) in the direction of its second position (FIG. 12c) when the soldered connection 9 is broken, in doing so an existing arc 10 and the plasma 14 are forced into the two component chambers 11′, 11″ in the housing 12. In addition, the arc 10 and part of the plasma 14 are also forced opposite the direction in which the interrupter 5 is moving into the channel 22 in the interrupter 5; this leads to a major elongation of the arc 10. Plasma 14 can escape from the housing 12 in the direction in which the interrupter 5 is moving through the outlet openings 15 which are made in the housing 12 and which are made on the side of the housing 12 which is opposite the isolating interrupter 5.

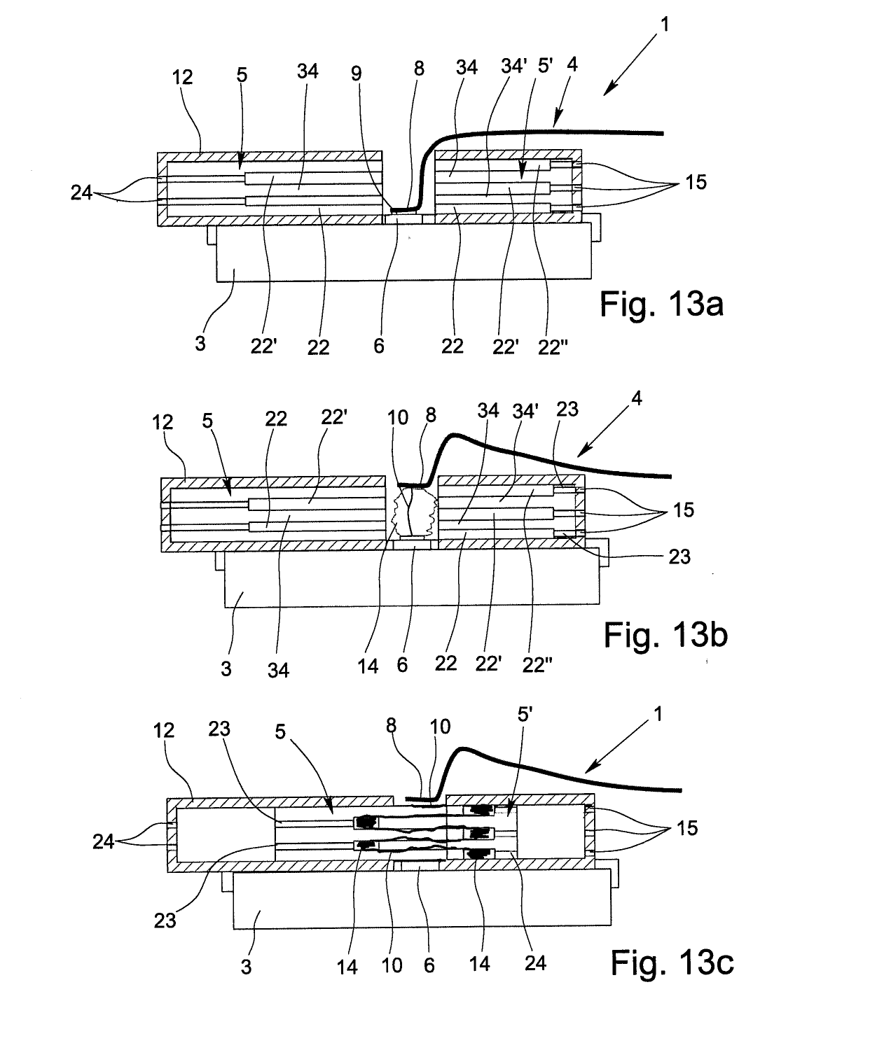

FIGS. 13a-13c shows yet another version of the exemplary embodiment of a surge suppressor 1 in accordance with the invention which is shown in FIGS. 6a-6c. In this exemplary embodiment, in the housing 12, there are two isolating interrupters 5, 5′ which are located on different sides of the first terminal 6 of the varistor 3 in the normal state of the varistor 3, i.e., the interrupter 5 is located on the left side and the interrupter 5′ is located on the right side of the terminal 6. In the first, left-hand interrupter 5 two channels 22, 22′ are made which are separated from one another by a partition 34. In the second, right-hand interrupter 5′ three channels 22, 22′, 22″ are made which are separated from one another by two partitions 34, 34′. The channels and partitions in the two interrupters 5, 5′ are arranged to one another such that the two isolating interrupters 5, 5′ intermesh when the two isolating interrupters 5, 5′ each move out of their first position into their second position. In this way, an arc 10 which arises after the soldered connection 9 is broken is forced in a meandering manner into the individual channels 22, 22′, 22″; this leads to a major increase of the length of the arc 10. At the same time, the plasma 14 is also forced into the individual channels 22, 22′, 22″ in the two isolating interrupters 5, 5′.

The plasma 14 can flow out of the channels 22, 22′, 22″ in the interrupters 5, 5′ in both directions into the housing 12 via outlet openings 23 which are made in the interrupters 5, 5′. In addition, outlet openings 15, 24 which have been made on the two ends of the housing 12 moreover enable controlled escape of the plasma 14 from the housing 12.

What is claimed is:

1. A surge suppressor, comprising:
a housing,
an overvoltage-limiting component which is located in the housing and has a first terminal and a second terminal,
an electrically conductive connecting element and
at least one isolating interrupter being movable relative to the first terminal of the overvoltage-limiting component from a first position into a second position,
wherein, in a normal state of the surge suppressor, a first end of the electrically conductive connecting element is connected to the first terminal of the overvoltage-limiting component in an electrically conductive manner and the isolating interrupter being held in said first position,
wherein, when a critical state of the overvoltage-limiting component is reached, the connection between the first end of the electrically conductive connecting element and the first terminal of the overvoltage-limiting component is constructed to break and the isolating interrupter being moved by force into said second position,
wherein, in said second position, a segment of the interrupter is located between a first end of the electrically conductive connecting element and the first terminal of the overvoltage-limiting component, and
wherein the at least one isolating interrupter is made such that an arc, which arises when the electrical connection between the first end of the electrically conductive connecting element and the first terminal of the overvoltage-limiting component is broken, is movable into at least one partially closed chamber by the at least one isolating interrupter.

2. The surge suppressor in accordance with claim 1, wherein, in the normal state of the surge suppressor, the first end of the electrically conductive connecting element is connected in an electrically conductive manner via a thermally breaking connection to the first terminal of the overvoltage-limiting component, the thermally breaking connection breaking when a boundary temperature of the overvoltage-limiting component is exceeded.

3. The surge suppressor in accordance with claim 1, wherein the isolating interrupter is located movably in a housing whose volume is greater than a volume of the interrupter, the housing has an opening through which, in the normal state of the surge suppressor, the first end of the electrically conductive connecting element is connected in an electrically conductive manner to the first terminal of the overvoltage-limiting component, and wherein the chamber is formed by a region of the housing in which, in the normal state of the surge suppressor, the isolating interrupter is not located.

4. The surge suppressor in accordance with claim 3, wherein the housing has an outlet opening in the region of the at least one partially closed chamber.

5. The surge suppressor in accordance with claim 1, wherein the isolating interrupter has an opening through which, in the normal state of the surge suppressor, the first end of the electrically conductive connecting element is connected in an electrically conductive manner to the first terminal of the overvoltage-limiting component.

6. The surge suppressor in accordance with claim 1, wherein at least one channel is provided in the isolating interrupter, the at least one channel being open on a side facing the chamber.

7. The surge suppressor in accordance with claim 6, wherein at least one web or one partition is provided within the housing, the at least one web or partition extending in a direction in which the isolating interrupter is moves so that the at least one web or the at least one partition divides the chamber in the housing into at least two component chambers.

8. The surge suppressor in accordance with claim 6, wherein the isolating interrupter has a least one outlet opening via which the channel is connected to the interior of the housing, the housing having at least one outlet opening.

9. The surge suppressor in accordance with claim 8, wherein the outlet opening in the isolating interrupter is made on a side facing away from the chamber and the outlet opening in the housing is opposite the outlet opening in the interrupter.

10. The surge suppressor in accordance with claim 6, wherein between the outlet opening in the isolating interrupter and the outlet opening in the housing, an outlet channel extends in the housing, a medium for cooling and/or damping of discharging plasma being provided in the outlet channel.

11. The surge suppressor in accordance with claim 3, wherein at least one of the housing and the isolating interrupter is formed at least in segments of a material which evolves gas.

12. The surge suppressor in accordance with claim 3, wherein the housing and/or the isolating interrupter consists of a mechanically and thermally stable material.

13. The surge suppressor in accordance with claim 3, wherein said at least one isolating interrupter comprises a plurality of isolating interrupters, wherein each interrupter is movably located in a respective housing, each housing having an opening, the openings being arranged relative to one another such that, in the normal state of the surge suppressor, the first end of the electrically conductive connecting element is connected through the openings in an electrically conductive manner to the first terminal of the overvoltage-limiting component.

14. The surge suppressor in accordance with claim 13, wherein, in the normal state of the surge suppressor, at least two isolating interrupters are located essentially on different sides of the first terminal of the overvoltage-limiting component, the isolating interrupters being movable in opposite directions relative to one another.

15. The surge suppressor in accordance with claim 1, wherein at least one channel is made in the isolating interrupter, wherein the at least one channel is open on a side facing the first terminal of the overvoltage-limiting component and forms a chamber into which an arc is movable, and wherein the first end of the electrically conductive connecting element is located in the channel in the isolating interrupter in the second position of the isolating interrupter.

16. The surge suppressor in accordance with claim 15, wherein, on a side of the first terminal of the overvoltage-limiting component on which the isolating interrupter is not located in the normal state of the surge suppressor, there is a sealing element which is adjoined by the isolating interrupter with the open side of the channel in its second position.

17. The surge suppressor in accordance with claim 15, wherein a first terminal projects from the overvoltage-limiting component, wherein a second channel is formed in the isolating interrupter which runs parallel to the first channel, and wherein, in the second position of the isolating interrupter the first end of the electrically conductive connecting element is located in the first channel and the terminal of the overvoltage-limiting component is located in the second channel.

18. The surge suppressor in accordance with claim 17, wherein at least one of the first channel and the second channel in the second position of the isolating interrupter adjoins a sealing element.

19. The surge suppressor in accordance with claim 17, wherein an outlet opening is provided in at least one wall of the isolating interrupter.
